(19) United States
(12) Patent Application Publication
(10) Pub. No.: US 2007/0136203 A1
(43) Pub. Date: Jun. 14, 2007

(54) Subscriber management system and method thereof in the digital multimedia broadcasting

(75) Inventors: Min-Suk Guahk, Gyeonggi-do (KR); Yong-soo Na, Seoul (KR); Duk-won Oh, Seoul (KR); Ju-Young Choi, Seoul (KR)

Correspondence Address: PEACOCK MYERS, P.C., 201 THIRD STREET, N.W., SUITE 1340, ALBUQUERQUE, NM, 87102, US

(73) Assignee: TU MEDIA CORPORATION, Seoul (KR)

(21) Appl. No.: 11/446,471

(22) Filed: Jun. 2, 2006

(30) Foreign Application Priority Data
Oct. 19, 2004 (KR) 10-2004-0083437
Oct. 17, 2005 (KR) PCT/KR05/03456

(51) Int. Cl. G06Q 99/00

(52) U.S. Cl. 705/51

(57) ABSTRACT

Disclosed are a subscriber management system and a method thereof using OOB (Out Of Band) channel in the DMB (Digital Multimedia Broadcasting). The system of the invention transmits a message for the alteration of the subscriber information to terminal through the OOB, and receives the result of the transmitting of message, that the result comprises a success of the transmitting/alteration, a failure of the alteration, and an error of the transmitting. Therefore, the system is able to apply the alteration of subscriber information to the terminal as soon as the subscriber information is altered.

### TECHNICAL FIELD

The present invention relates to a subscriber management system and method thereof in the digital multimedia broadcasting, and more particularly, to a subscriber management system and method thereof in the digital multimedia broadcasting which manages a subscriber in the digital multimedia broadcasting.

### BACKGROUND ART

The digital multimedia broadcasting is the broadcasting service which can view and listen various multimedia broadcasting such as video, audio or data by the multimedia channels through a personal portal or an automotive incoming terminal mounting the receiving antenna outdoors or on walking.

The service provides a high quality of tone, various data services, interactivity and good moving reception quality by converting a conventional analog broadcasting signal into a digital signal and enhance conventional broadcasting concept in the manner that a user views, listens and participates the broadcasting. And the service, except for the music broadcasting, can transmit various multimedia broadcasting such as news, traffic information, weather information, geographic position information and moving picture information as the pattern of text and graph through the data broadcasting.

On the other hand, generally, the above-mentioned digital multimedia broadcasting uses a CAS (Conditional Access System) for restricting the reception of subscribers. The CAS performs the reception restriction function by adjusting the viewing grade through a smart cast mounted in an incoming terminal, and performs the security function preventing from viewing digital multimedia broadcasting through the illegal use of the smart card.

But whether the incoming terminal received a message transmitted to the incoming terminal from the CAS or not is not able to be identified and the CAS message is transmitted to the incoming terminal of all subscribers every 30 minutes. Therefore, the incoming terminal had to wait the next CAS message in the case that the CAS message is not received at a time.

Hereinafter, preferable embodiments according to the conventional art will be described with reference to the accompanying drawings.

FIG. 1 illustrates a block diagram of a subscriber management system in the digital multimedia broadcasting in accordance with the conventional art.

As depicted in FIG. 1, the subscriber management system in the digital multimedia broadcasting in accordance with the conventional art comprises a BIS (Business Information System) 110 for managing subscriber information of the digital multimedia broadcasting, a CAS (Conditional access system) 120 for generating a CAS message related to the viewing qualification of a subscriber and the viewing grade of the fee channel at predetermined intervals and transmitting the CAS message to an incoming terminal through a broadcasting network, an incoming terminal 130 for receiving a broadcasting signal and the CAS message transmitted through the broadcasting network, analyzing the CAS message and then displaying only a broadcasting signal corresponding to the viewing grade.

Herein, the incoming terminal 130 includes a smart card 135 for storing the subscriber information, receiving the CAS message and then adjusting and modifying the viewing grade.

A subscriber management system in the digital multimedia broadcasting in accordance with the conventional art will be described.

At first, the BIS 110 performs the management such as the generation, the modification and the stop of subscriber information (namely, information of an incoming terminal, a smart card and subscriber) in the digital multimedia broadcasting and simultaneously transmits the serial number of a smart card of a corresponding subscriber incoming terminal to the CAS 120 together with the alteration recording if the alteration such as the generation, the modification and the stop of subscriber information is generated.

The CAS 120 generates a CAS message including the serial number of a smart card and the alteration recording thereof transmits (broadcasts) the same to all incoming terminals 120. Namely, the CAS 120 manages a user's viewing qualification and the viewing grade of the fee channel through the CAS message. At this time, the CAS message includes the message that relates to information (EMM; Entitlement Management Message) of a user's viewing qualification and the viewing grade of the fee channel, and relates to key information (ECM; Entitlement Control Message) which can decrypt the scramble of the fee channel.

Accordingly, the incoming terminal 130 receives the CAS message from a broadcasting network and manages a user's viewing qualification and the viewing grade of the fee channel through the EMM (Entitlement Management Message) in the case that the CAS message is the same to key information of the built-in smart card 135 by analyzing (namely, parsing) the ECM (Entitlement Control Message).

However, as described above, conventional art have the problem that because the CAS message is transmitted to all incoming terminals 120 at every 30 minutes, the varied viewing qualification and viewing grade of the fee channel are not entitled on time in the case that an incoming terminal in the shadow area doesn't receive the CAS message.

In addition, there is the problem that because a broadcasting network has the unilateral characteristics, digital multimedia broadcasting operator cannot correctively know whether the CAS message transmitted to an incoming terminal through the broadcasting network is received.

### DISCLOSURE OF INVENTION

### Technical Problem

Accordingly, it is an object of the present invention to provide a subscriber management system and method thereof in the digital multimedia broadcasting using a channel out of band.

### Technical Solution

It is a first aspect of the present invention to provide a subscriber management system in the digital multimedia broadcasting, the system comprising: a broadcasting center for performing the subscriber management by transmitting a broadcasting signal through a channel in band and transmitting a message through a channel out of band and then performing the feedback of the same; and an incoming terminal for analyzing the message and then displaying a broadcasting signal transmitted through the channel in band on the screen in the basis of the viewing qualification and the viewing grade in accordance with the analyzing result.

It is a second aspect of the present invention to provide a subscriber management system and method thereof in the digital multimedia broadcasting, the system comprising: a customer management apparatus for managing subscriber information in the digital multimedia broadcasting; a conditional access system for generating a message related to the viewing qualification and the viewing grade of the digital multimedia broadcasting in accordance with the alteration of the subscriber information; a mobile station server for selecting a telecommunication network to transmit the message; a telecommunication server for converting the message into the data type for transmitting through the telecommunication network and then transmitting the converted message through the selected telecommunication network; and an incoming terminal for analyzing the message and then displaying a broadcasting signal transmitted through the broadcasting network on the screen in the basis of the viewing qualification and the viewing grade in accordance with the analyzing result.

It is a third aspect of the present invention to provide a subscriber management method in the digital multimedia broadcasting, the method comprising the steps of: (a) a broadcasting center for transmitting a message for the alteration of the subscriber information through a channel out of band; and (b) receiving information corresponding to the success, the failure and the error of the message transmission as the feedback.

It is a fourth aspect of the present invention to provide a subscriber management method in the digital multimedia broadcasting, the method comprising the steps of: (a) transmitting a message corresponding to the alteration of subscriber information to the conditional access system in the case that a customer management apparatus changes subscriber information; (b) the conditional access system of generating a subscriber change message in the basis of the command message and then transmitting the same to mobile station server; (c) the mobile station of analyzing the subscriber change message and then transmitting the subscriber change message to a telecommunication server of a corresponding telecommunication operator; (d) the telecommunication server of processing into a data type which is able to be transmitted through a telecommunication network, and then transmitting the same to an incoming terminal; and (e) the incoming terminal of parsing the subscriber change message, performing an operation corresponding to the alteration of corresponding subscriber information in the case that a smart card number and included at the subscriber change message is the same to a smart card number of the incoming terminal, receiving a broadcasting signal transmitted through a broadcasting network, and then displaying the same on the screen.

### ADVANTAGES EFFECTS

As described above, the present invention applies the alteration items to the incoming terminal as soon as the alteration of the subscriber information is generated by the digital multimedia broadcasting using a channel out of band (for example, telecommunication network).

The present invention can provide subscriber with a reliable service because whether the alteration message of the subscriber information is correctively transferred to the incoming terminal can be identified as soon as the alteration of the subscriber information is generated by the digital multimedia broadcasting using a channel out of band (for example, telecommunication network).

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

### BRIEF DESCRIPTION OF THE DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 illustrates a block diagram of a subscriber management system in the digital multimedia broadcasting in accordance with the conventional art;

FIG. 2 illustrates a block diagram of a subscriber management system in the digital multimedia broadcasting in accordance with an exemplary embodiment of the present invention;

FIG. 3 illustrates a command message in accordance with an exemplary embodiment of the present invention;

FIG. 4 illustrates a SOROOB command message in accordance with an exemplary embodiment of the present invention; and

FIG. 5 illustrates an EMM (Entitlement Management Message) in accordance with an exemplary embodiment of the present invention.

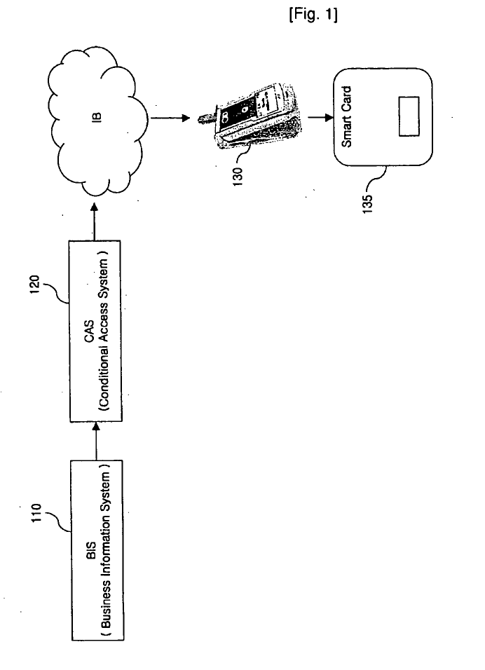

The following Examples are given for the purpose of illustration only and are not intended to limit the scope of this invention.

### BEST MODE FOR CARRYING OUT THE INVENTION

Hereinafter, preferable embodiments according to the present invention will be described with reference to the accompanying drawings. Here, when one element is connected to another element, one element may be not only directly connected to another element but also indirectly connected to another element via another element. Further, irrelative elements are omitted for clarity. Also, like reference numerals refer to like elements throughout.

The channel out of band has various kinds of forms like a telecommunication network and an IP based packet network, etc. however, the preferable embodiment of the present invention will be explained on the basis of the telecommunication network for the telecommunication service propelled together with the digital multimedia broadcasting.

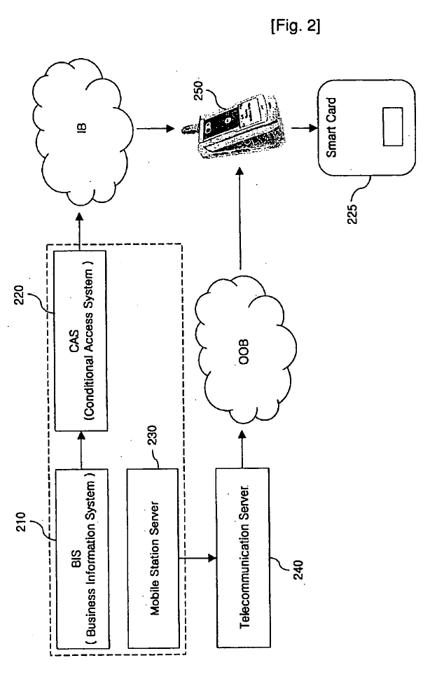

FIG. 2 illustrates a block diagram of a subscriber management system in the digital multimedia broadcasting in accordance with an exemplary embodiment of the present invention.

As depicted in FIG. 2, the customer management apparatus for managing subscriber information in the digital multimedia broadcasting comprises a BIS (Business Information System) 210 for managing subscriber information in the digital multimedia broadcasting; a CAS (Conditional Access System) 220 for generating an EMM (Entitlement Management Message) in accordance with the alteration of the subscriber information and for transmitting the EMM (Entitlement Management Message) to a mobile station server; the mobile station server 230 for receiving the EMM (Entitlement Management Message) and transmitting EMM (Entitlement Management Message) to a telecommunication server of a telecommunication operator corresponding to the number of an incoming terminal included at the EMM (Entitlement Management Message); the telecommunication server 240 for transmitting the EMM (Entitlement Management Message) generated from the mobile station server to an incoming terminal through the telecommunication network; and the incoming terminal 250 for receiving the EMM (Entitlement Management Message) transmitted through the telecommunication network, analyzing the EMM (Entitlement Management Message) and then displaying a signal transmitted through a broadcasting network on a screen in accordance with the viewing grade. Herein, the incoming terminal 250 stores includes a smart card 255 which stores subscriber information, receives the EMM (Entitlement Management Message) and adjusts and modifies the viewing grade

In addition, the BIS 210, the CAS and the mobile station server 230 is equipped inner side of a broadcasting center (not shown).

The BIS 110 performs the management such as the generation, the modification and the stop of subscriber information (namely, information of an incoming terminal, a smart card and subscriber) in the digital multimedia broadcasting and simultaneously transmits the serial number of a smart card of a corresponding subscriber incoming terminal 250 together with the alteration recording to the CAS 220 if the alteration (namely, event) such as the generation, the modification and the stop of subscriber information is generated. It is preferable that the information of an incoming terminal is the number of the incoming terminal (for example, MDN).

The CAS 220 generates an EMM (Entitlement Management Message) including the serial number of a smart card and the alteration recording thereof and transmits the same to the incoming terminals 250 through the mobile station server 230, the telecommunication server 240 and a telecommunication network. Namely, the CAS 220 manages a user's viewing qualification and the viewing grade of the fee channel through the EMM (Entitlement Management Message). At this time, the EMM (Entitlement Management Message) includes information of a user's viewing qualification, the viewing grade of the fee channel and the serial number of a smart card. Accordingly, only the incoming terminal 250, which is the same to the serial number of a smart card, modifies information of a user's viewing qualification, the viewing grade of the fee channel. At this time, the CAS (Conditional Access System) 220 transmits the EMM (Entitlement Management Message) including information as to whether subscriber is authenticated or may be dependently transmit only message including the alteration recording and information as to whether subscriber is authenticated on behalf of the EMM (Entitlement Management Message).

The mobile station server 230 plays a role on a message analysis server between the CAS 220 and the telecommunication server 240 of the telecommunication network, stores information which is able to divisionally manage a session in accordance with respective telecommunication agency (namely, service provide) at the EMM (Entitlement Management Message) and then transmits the telecommunication server 240 of the telecommunication network by packaging the EMM (Entitlement Management Message) as the format that the telecommunication server 240 is able to receive.

In addition, the mobile station server 230 includes separate management module for managing the success, the failure and error information of the EMM transmission of the telecommunication server 240 to the incoming terminal 250. For example, the management module become a basis of the EMM re-transmission of the CAS 220 of the mobile station server 230 by receiving success, the failure and error information of the EMM transmission from the incoming terminal 250 as the feedback through a Callback URL of an SMS (Short Message Service) transmitted to the incoming terminal 250 using the management module and transmitting the same to CAS 220.

The telecommunication server 240 is built in accordance with respective service provider, processes the EMM into the data format (for example, an OTA (Over The Air), an SMS (Short Message Service) and a data packet) which is able to transmit the EMM through the telecommunication network and transmits the same to the incoming terminal 250. The telecommunication server 240 plays a role in being included at the mobile station server 230 in accordance with the kind of a channel out of band or being provided as a relay server (not shown).

The incoming terminal 250 is classified as an incoming terminal which simultaneously performs the function of the terminal for the digital multimedia broadcasting and a telecommunication service. At this time, the incoming terminal 250 applied to the exemplary embodiment in accordance with the present invention is limited to the compatible incoming terminal. And the incoming terminal 250 receives the EMM, analyzes the same and decides on the viewing qualification and the viewing grade of the fee channel in the case that the serial number of the smart card included at the EMM is the same to the number of the built-in smart card and displays on a screen by receiving a broadcasting signal transmitted through a broadcasting network.

Hereinafter, the operation of a subscriber management system in the digital multimedia broadcasting in accordance with an exemplary embodiment of the present invention will be explained.

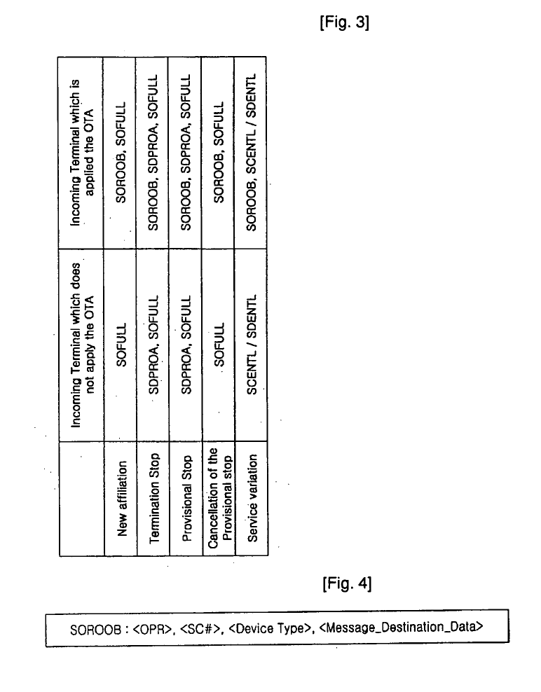

The BIS 210 shares information related to the possibility of a telecommunication service with the CAS 220 by transmitting a SOROOB command to the CAS 220 whenever the opening and goods in the digital multimedia broadcasting service are varied (hereinafter, the event generation). For the operation, the BIS 210 discriminates whether correspond incoming terminal is used as a mobile phone through a subscriber information inquiry in case of the event generation. If the correspond incoming terminal is not used as a mobile phone in the discrimination result, because the fact of the event generation has to be transmitted, as depicted in FIG. 3, a command message for an incoming terminal which does not apply the telecommunication service is transmitted to the CAS 220. Herein, the SOROOB message has the structure as depicted in FIG. 4.

Namely, ┌SC#┘ represents the serial number of the smart card 255, ┌Device Type┘ includes information as to whether the incoming terminal is not applied to the telecommunication service, and ┌Message_Destination_Data┘ includes classification information of the telecommunication service operator and the telephone number (for example, MDN) of the incoming terminal 250.

And it is preferable that because the interworking of real time subscriber information between a subscriber management system of the telecommunication service operator in case of the event generation with the BIS 210 is not easy, the SOROOB message is firstly transmitted to the CAS 220 and the event generation message is next transmitted.

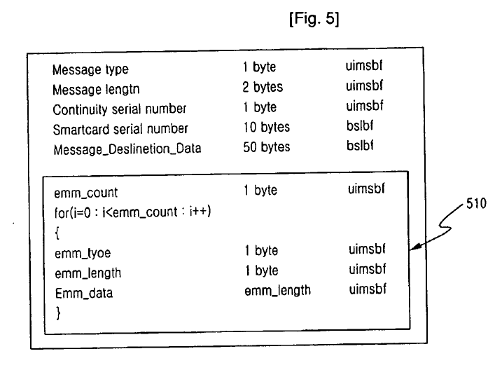

The CAS 220 generates the EMM on the basis of the command message transmitted from the BIS 210 and transmits the same to the mobile station server 230. At this time, the EMM transmitted to the mobile station server 230 from the CAS 220 is defined as depicted in FIG. 5. In addition, the EMM has not the TS format but the encrypted binary state, and includes at least one of the EMM as depicted in the numeral reference 510 of FIG. 5.

The mobile station server 230 analyzes the EMM inputted from the CAS 220 and transmits the EMM to the telecommunication server 240 of corresponding telecommunication service operator. And the mobile station server 230 manages whether the EMM is correctively transmitted to the telecommunication server 240. Namely, a retrial is adjusted against the transmission failure. In addition, the mobile station server 230 monitors the state of the EMM and the transmission recording, and includes the function of the duplexing management and the statistics management.

The telecommunication server 240 processes the EMM into the data type (for example, an OTA (Over The Air), an SMS (Short Message Service) and a data packet) which can be transmitted through a telecommunication network and transmits the same to the incoming terminal 250.

The incoming terminal 250 receives the EMM, analyzes the same and decides on the viewing qualification and the viewing grade of the fee channel in the case that the serial number of the smart card included at the EMM is the same to the number of the built-in smart card, and displays on a screen by receiving a broadcasting signal transmitted through a broadcasting network. And as the incoming terminal 250 transmits a response message of the EMM to the telecommunication server 240 through the telecommunication network, the telecommunication service operator identifies whether the EMM is correctively transmitted to the incoming terminal 250.

Herein, the smart card 255 includes a broadcasting module (not shown), transmits the EMM by enabling the state of the broadcasting module to be on the ON in the case that the state of the broadcasting module is on the OFF, and then again enables the state of the broadcasting module to be on the OFF.

According to the above-mentioned method, the fact (the generation, the modification and the stop of subscriber information) as to whether the event generation can be correctively transmitted to an incoming terminal on time through a telecommunication network on behalf of a broadcasting network.

While the invention is susceptible to various modifications and alternative forms, specific embodiments thereof have been shown by way of example in the drawings and are herein description in detail. It should be understood, however, that the description herein of specific embodiments is not intended to limit the invention to the particular forms disclosed, but on the contrary, the invention is to include all modifications, equivalents and alternatives falling within the spirit and scope of the invention as defined by the appended claims.

### INDUSTRIAL APPLICABILITY

The present invention is able to manage a subscriber in the digital multimedia broadcasting using a channel out of band.

What is claimed is:

1. Subscriber management system in digital multimedia broadcasting, the system comprising:
a BIS (Business Information System) for managing subscriber information in the digital multimedia broadcasting;
a conditional access system for generating a message related to the viewing qualification and the viewing grade of the digital multimedia broadcasting in accordance with the alteration of the subscriber information;
a mobile station server for selecting a telecommunication network to transmit the message;
a telecommunication server for converting the message into the data type for transmitting through the telecommunication network and then transmitting the converted message through the selected telecommunication network; and
an incoming terminal for analyzing the message and then displaying a broadcasting signal transmitted through the broadcasting network on the screen in the basis of the viewing qualification and the viewing grade in accordance with the analyzing result.

2. The system as claimed in claim 1, wherein the BIS (Business Information System) includes a discrimination means for discriminating the kind and the capability of the incoming terminal through the subscriber information.

3. The system as claimed in claim 1, wherein the BIS (Business Information System), whenever the opening and goods in the digital multimedia broadcasting service are varied, discriminates whether the service is applied to the incoming terminal or not and then transmits respective different commands to the conditional access system.

4. The system as claimed in claim 3, wherein the commands applied to the digital multimedia broadcasting service include information related to a smart card, the classification of a mobile service provider and the telephone number of the incoming terminal.

5. The system as claimed in claim 1, wherein the conditional access system includes a message generation means having a command corresponding to at least one of the new affiliation, the termination and the provisional stop of the service, cancellation of the provisional stop and the service variation within the message in the basis of the variation of the subscriber information.

6. The system as claimed in claim 5, wherein the message generation means further includes the telephone number of the incoming terminal within the message.

7. The system as claimed in claim 1, wherein the mobile station server comprises:
a selection means for selecting a mobile communication network operator in the basis of the subscriber information included within the message; and
a management means for receiving information corresponding to the success, the failure and the error of the message transmission as the feedback and then transmitting the same to the conditional access system.

8. The system as claimed in claim 1, wherein the incoming terminal includes a smart card for analyzing subscriber information included at the message and receiving a broadcasting signal only when the broadcasting signal is the same to the subscriber information.

9. The system as claimed in claim 8, wherein the smart card transmits a subscriber change message by enabling the reception state of digital multimedia broadcasting to be in the ON state in the case that the broadcasting reception state is in the OFF state, and then again enabling the broadcasting reception state to be in the OFF state.

10. The system as claimed in claim 1, wherein the data type is any one of an OTA (Over The Air), an SMS (Short Message Service) and a data packet.

11. Subscriber management system in digital multimedia broadcasting, the system comprising:
a broadcasting center for performing the subscriber management by transmitting a broadcasting signal through a channel in band and transmitting a message through a channel out of band and then performing the feedback of the same; and
an incoming terminal for analyzing the message and then displaying a broadcasting signal transmitted through the channel in band on the screen in the basis of the viewing qualification and the viewing grade in accordance with the analyzing result.

12. The system as claimed in claim 11, wherein the mobile station server comprises:
a conditional access system for generating a message related to the viewing qualification and the viewing grade of the digital multimedia broadcasting in accordance with the alteration of the subscriber information; and
a mobile station server for selecting a channel out of band to transmit the message, processing into a data type which is able to be transmitted through the channel out of band, and then transmitting the same.

13. The system as claimed in claim 12, wherein the conditional access system includes a message generation means having a command corresponding to at least one of the new affiliation, the termination and the provisional stop of the service, cancellation of the provisional stop and the service variation within the message in the basis of the variation of the subscriber information.

14. The system as claimed in claim 12, wherein the mobile station server comprises:
a selection means for selecting a mobile communication network operator in the basis of the subscriber information included within the message; and
a management means for receiving information corresponding to the success, the failure and the error of the message transmission as the feedback and then transmitting the same to the conditional access system.

15. The system as claimed in claim 11, wherein the channel out of band is a telecommunication network.

16. The system as claimed in claim 11, wherein the incoming terminal includes a smart card for analyzing subscriber information included at the message and receiving a broadcasting signal only when the broadcasting signal is the same to the subscriber information.

17. The system as claimed in claim 16, wherein the smart card transmits a subscriber change message by enabling the reception state of digital multimedia broadcasting to be in the ON state in the case that the broadcasting reception state is in the OFF state, and then again enabling the broadcasting reception state to be in the OFF state.

18. Subscriber management method in digital multimedia broadcasting, the method comprising the steps of:
a broadcasting center transmitting a message for the alteration of the subscriber information through a channel out of band; and
receiving information corresponding to the success, the failure and the error status of the message transmission as feedback.

19. The method as claimed in claim 18, wherein the channel out of band is a telecommunication network.

20. The method as claimed in claim 18, wherein the alteration of the subscriber information is any one of the new affiliation, the termination and the provisional stop of the service, cancellation of the provisional stop and the service variation.

21. Subscriber management method in digital multimedia broadcasting, the method comprising the steps of:
transmitting a message corresponding to the alteration of subscriber information to a conditional access system in the case that a BIS (Business Information System) changes subscriber information;
the conditional access system generating a subscriber change message on the basis of the command message and then transmitting the same to mobile station server;
the mobile station analyzing the subscriber change message and then transmitting the subscriber change message to a telecommunication server of a corresponding telecommunication operator;
the telecommunication server processing into a data type which is able to be transmitted through a telecommunication network, and then transmitting the same to an incoming terminal; and
the incoming terminal parsing the subscriber change message, performing an operation corresponding to the alteration of corresponding subscriber information in the case that a smart card number and included at the subscriber change message is the same to a smart card number of the incoming terminal, receiving a broadcasting signal transmitted through a broadcasting network, and then displaying the same on the screen.

22. The method as claimed in claim 21, wherein the transmitting step comprises the steps of:
discriminating whether the kind of a corresponding subscriber incoming terminal can use a telecommunication service together with a digital multimedia broadcasting service in the case that a BIS (Business Information System) changes subscriber information; and
transmitting a command message corresponding to the alteration of subscriber information and the discriminating result to the conditional access system.

23. The method as claimed in claim 22, wherein the command message includes the possibility of applying the incoming terminal to a telecommunication service, a telephone number of the incoming terminal and a serial number of a smart card.

24. The method as claimed in claim 21, wherein the subscriber change message is transmitted as an encrypted binary state.

25. The method as claimed in claim 21, wherein the subscriber change message includes information distinguishing a telecommunication service from a digital multimedia broadcasting service.

26. The method as claimed in claim 21, wherein the processing step comprises the step of transmitting a response message corresponding to the reception state of a corresponding message to the telecommunication server, by the incoming terminal receiving the subscriber change message.

27. The method as claimed in claim 21, wherein the parsing step further comprises the step of transmitting the subscriber change message by enabling a DMB (Digital Multimedia Broadcasting) module to be in the ON state in the case that the DMB module is in the OFF state, and then again enabling the DMB module to be in the OFF state.
